(19) United States
(12) Patent Application Publication
(10) Pub. No.: US 2002/0076133 A1
(43) Pub. Date: Jun. 20, 2002

(54) Guided wave optical switch based on an active semiconductor amplifier and a passive optical component

(76) Inventors: Xun Li, Waterloo (CA); Wei-Ping Huang, Ancaster (CA); Chenglin Xu, Burlington (CA); Yi Liang, San Diego, CA (US)

Correspondence Address: STROOCK & STROOCK & LAVAN, LLP, 180 Maiden Lane, New York, NY, 10038, US

(21) Appl. No.: 09/789,368

(22) Filed: Feb. 20, 2001

Related U.S. Application Data
(60) Provisional application No. 60/183,315, filed on Feb. 17, 2000.

(51) Int. Cl. G02B 6/35; G02B 6/12; G02B 6/10

(52) U.S. Cl. 385/16; 385/17; 385/14; 385/129

(57) ABSTRACT

A guided wave optical switch having a passive optical component optically coupled to a low gain optical amplifier—both being formed monolithically in a semiconductor substrate. The passive optical component may comprise a single-mode −3 dB optical power splitter that receives at an input an optical signal and splits that optical signal approximately equally between two outputs. The passive optical component may also comprise an optical isolator, an optical circulator, and other known passive optical devices. The low gain optical amplifier includes a waveguide having an active region that may provide optical signal gain when excited by an electrical current provided by a metal or metallic electrode connected to the active region. The active region may be a bulk active region, a multiple quantum well active region, or the waveguide may comprise a buried heterojunction waveguide having either a bulk or multiple quantum well active region.

### CROSS-REFERENCE TO RELATED APPLICATION

This application claims priority to Provisional Patent Application Serial No. 60/183,315, filed on Feb. 17, 2000.

### FIELD OF THE INVENTION

The present invention is directed to guided wave optical switches including an optical amplifier and a passive optical component formed monolithically in a semiconductor substrate.

### BACKGROUND OF THE INVENTION

High-performance, low-cost optical switches are key components for intelligent broadband optical networks. For optical switches operable at switching speeds in the nanosecond range, few semiconductor materials provide the necessary optical properties and characteristics to permit their use in constructing an optical switch suitable for operation at such switching speeds, e.g., InP and LiNbO₃. Current techniques for constructing optical switches typically include fabricating separate passive and active components, and interconnecting those separate components. In addition to the time and cost disadvantages of such techniques, optical interconnections, required between passive and active components inevitably result in optical signal loss and/or degradation. Monolithic fabrication may eliminate some of the problems associated with mating two optical components together (e.g., an optical splitter and amplifier) such as, for example, coupling loss and signal reflection. In addition, monolithic fabrication of optical switches and switch fabric (i.e., switch matrices) may utilize mature semiconductor fabrication techniques leading to higher production yield and higher device performance.

However, materials typically used for passive components such as glass, SiO₂, polymer or Si, can not emit light, making it impossible to provide active components on a substrate constructed of such materials. On the other hand, if a group III-V compound such as InP is chosen as the substrate, formation of passive components is also problematic. Thus, monolithic integration of the passive and the active components can only be done using semiconductor materials having a direct band-gap, e.g., most of the group III-V compounds. For example, the relative difference between the refractive index of the InP substrate and air results in high coupling losses because the light beam coming out of the waveguide has a large divergence angle making alignment of an optical fiber to the waveguide very difficult. Also, the lower limits on the doping concentration of the InP semiconductor material leads to high propagation loss within the components since the light suffers a significant scattering loss when propagating along the waveguide. In addition, it is very difficult to design a single-mode waveguide without polarization dependent loss, even for a square-shaped waveguide, because of the unacceptable surface roughness at the horizontal and the vertical boundaries of the waveguide. Consequently, the TE and the TM polarization modes will have different boundary scattering loss which may lead to a large Polarization Dependent Loss (PDL).

Thus, while it is desirable to monolithically fabricate optical components, such as optical splitters and amplifiers, for example, current fabrication methods do not permit such fabrication.

### SUMMARY OF THE INVENTION

The present invention is directed to a guided wave optical switch having a passive optical component optically coupled to a low gain optical amplifier—both being formed monolithically in a semiconductor substrate. The passive optical component may comprise a single-mode −3 dB optical power splitter that receives at an input an optical signal (also referred to herein as a light signal) and splits that optical signal equally between two outputs. The passive optical component may also comprise an optical isolator, an optical circulator, and other known passive optical components. The low gain optical amplifier includes a waveguide having an active region that may provide optical signal gain when excited by an electrical current provided by a metal or metallic electrode connected to the active region. The active region may be a bulk active region, a multiple quantum well active region, or the waveguide may comprise a buried heterojunction waveguide having either a bulk or multiple quantum well active region.

The optical amplifier has input and output facets, at least one of which is anti-reflective to light. In one embodiment of the present invention, both facets are anti-reflective. Thus, a light signal enters the optical amplifier through an input facet (i.e., that facet through which light first enters the optical amplifier), is amplified in the active region, and exits the amplifier through an output facet (i.e., the facet located longitudinally opposite of the input facet). In an alternative embodiment, an input facet is anti-reflective, while the output facet is highly reflective to light. In that embodiment, light enters the optical amplifier through the input facet, is amplified in the active region, is reflected by the output facet (i.e., by the highly reflective facet), and exits the amplifier through the input facet.

The passive optical component and optical amplifier of the inventive switch are optically coupled by a plurality of waveguides monolithically formed in the semiconductor substrate and that may comprise photonic-wire or photonic-well waveguides, and that may be polarization insensitive. Light input to and output from the inventive optical switch may also be via a plurality of waveguides monolithically formed in the semiconductor substrate.

The amplifier waveguide may include either mode evolution or mode conversion mode size converters, to improve the coupling efficiency between the optical amplifier and external fiber-optic cables and connectors.

The present invention uses a modified conventional semiconductor optical amplifier (SOA) structure in which both of the active region and the cladding layer are modified to reduce the polarization sensitivity and the gain recovery time by sacrificing the optical gain. More specifically, for a SOA with a bulk active region, the core is thicker than that of a conventional SOA. For a buried heterojunction structure, the core is narrowed to approximately 0.7 μm. Those new designs provide a core having a quasi-square shape (i.e., generally symmetrical) which tends to reduce polarization sensitivity. For a SOA having a multiple quantum well (MQW) active region, mixed compressive and tensile strained quantum wells are used together with a TE/TM mode confinement configuration to balance TE and TM modal gains.

Although the present invention utilizes standard fiber-optic components (FOC) at the switch input and output stages, FOCs with a larger numerical aperture are used for the internal connections in order to reduce the coupling loss between the SOA chips and external fibers.

In addition to lower cost and higher yield, the present invention is operable at higher switching speeds, exhibits zero insertion loss or even gain, and has a large extinction ratio (the ratio of the power of a plane-polarized beam that is transmitted through a polarizer placed in its path with its polarizing axis parallel to the beam's plane, as compared with the transmitted power when the polarizer's axis is perpendicular to the beam's plane).

The present invention also utilizes the low gain region of a SOA. In the present invention, a fiber-to-fiber gain of approximately 3 dB is sufficient for 1×N and N×N non-matrix switches, and a maximum gain of approximately 6 dB is sufficient for N×N matrix switches. The present invention also provides a scaleable matrix switch. Thus, the present invention utilizes a plurality of low gain (i.e., 3 dB) SOA devices instead of using fewer high gain (i.e., >6 dB) SOA devices. The low gain SOAs of the present invention are also combined with fiber components (e.g., FOCs), instead of being coupled with other types of waveguides. That construction and configuration produces various switch architectures (e.g., matrix and non-matrix) that have heretofore not been known.

The invention accordingly comprises the features of construction, combination of elements, and arrangement of parts which will be exemplified in the disclosure herein, and the scope of the invention will be indicated in the claims.

### BRIEF DESCRIPTION OF THE DRAWINGS

In the drawing figures, which are not to scale, and which are merely illustrative, and wherein like reference characters denote similar elements throughout the several views:

FIG. 1 is a diagrammatic view of an optical switch having a passive splitter optically coupled to a semiconductor optical amplifier having anti-reflective coating on both facets and constructed in accordance with an embodiment of the present invention;

FIG. 2 is a diagrammatic view of an optical switch having a plurality of passive optical components optically coupled to a semiconductor optical amplifier having anti-reflective coating on one facet and high reflective coating an another facet and constructed in accordance with an embodiment of the present invention;

FIG. 3 is a longitudinal side view of a semiconductor amplifier having a single waveguide and having anti-reflective coating on both facets;

FIG. 4 is a longitudinal side view of a semiconductor amplifier having two generally parallel waveguides, each having anti-reflective coating on both facets;

FIG. 5 is a longitudinal side view of a semiconductor amplifier having a single waveguide and having anti-reflective coating on one facet and high reflective coating an another facet;

FIG. 6 is a longitudinal side view of a semiconductor amplifier having two generally parallel waveguides, each having anti-reflective coating on one facet and high reflective coating an another facet;

FIG. 7 is a longitudinal side view of a semiconductor amplifier having a single waveguide and having monolithically integrated mode size converters based on mode evolution;

FIG. 8 is a longitudinal side view of a semiconductor amplifier having a single waveguide and having monolithically integrated mode size converters based on mode interference;

FIG. 9 is a schematic view of a monolithically formed 1×N optical switch constructed of a plurality of 1×2 guided wave optical switches constructed in accordance with the present invention;

FIG. 10 is a schematic view of a monolithically formed 2×2 optical switch constructed of a plurality of 1×2 guided wave optical switches constructed in accordance with the present invention;

FIG. 11 is a schematic view of a monolithically formed 2×2 optical switch constructed of two 1×2 single-pass 6 dB gain guided wave optical switches constructed in accordance with the present invention;

FIG. 12 is a schematic view of a monolithically formed 2×2 optical switch constructed of four 1×2 single-pass 6/3 dB gain guided wave optical switches constructed in accordance with the present invention;

FIG. 13 is a cross-sectional view of a multiple quantum well active region of a waveguide of a semiconductor optical amplifier constructed in accordance with an embodiment of the present invention;

FIGS. 14A and 14B are cross-sectional and longitudinal views of a transverse semiconduct or amplifier having a buried heterojunction waveguide and constructed in accordance with the present invention;

FIGS. 15A and 15B are cross-sectional and longitudinal views of a transverse semiconductor amplifier having a ridge waveguide and constructed in accordance with the present invention; and

FIG. 16 is a table including ratios of semiconductor materials suitable for construction of a multiple quantum well active region in accordance with an embodiment of the present invention.

### DETAILED DESCRIPTION OF THE PRESENTLY PREFERRED EMBODIMENTS

The present invention is directed to a guided wave optical switch monolithically formed in a semiconductor substrate and having a passive optical component optically coupled to a low gain optical amplifier.

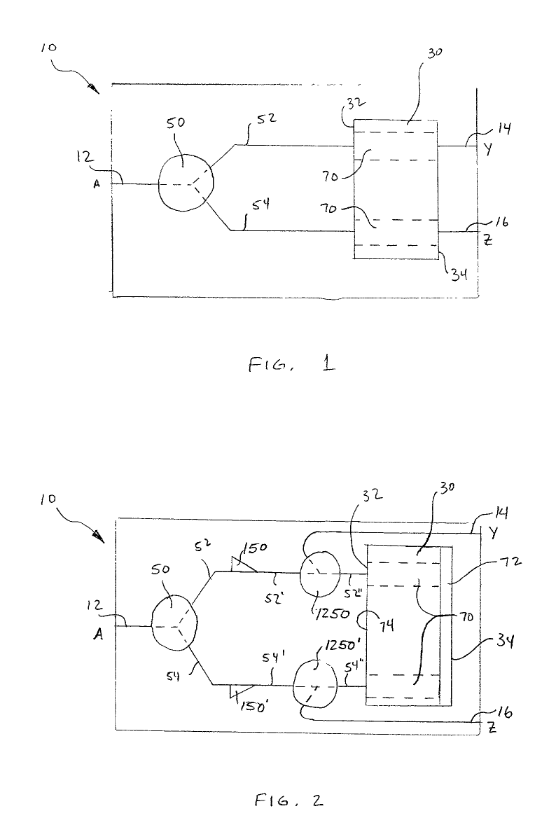

Referring now to the drawings in detail, a guided wave optical switch constructed in accordance with an embodiment of the present invention is depicted in FIG. 1 and generally designated by reference numeral 10. The switch 10 is monolithically formed in a semiconductor substrate such as, for example, InP or LiNbO₃ or other III-V semiconductor. Other semiconductor materials may also be used to construct a guided wave optical switch 10 in accordance with the present invention and the disclosure provided herein, as a routine matter of design choice. An input of the switch 10 is designated by reference letter A and comprises an input waveguide 12 which may receive a light signal from an optical source (not shown) via a fiber-optic cable (not shown) connected to the switch 10 using known techniques and devices. The input waveguide 12 provides an optical path and guides the light signal to a passive optical component 50, depicted as a −3 dB optical power splitter in FIG. 1 having two outputs. An optical signal input to the splitter 50 is divided equally (in terms of optical power) between the two outputs, which are provided in the form of waveguides 52, 54 that provide an optical path between the splitter 50 and a two-input, two-output, single-pass, 3 dB gain optical amplifier 30. The gain characteristic of the optical amplifier 30 is a routine matter of design choice, and may be greater than or less than 3 dB. For example, Two waveguides 14, 16 provide optical path outputs for light signals from the amplifier and also provide two outputs of the switch 10, generally designated by reference letters Y and Z. In operation, an optical signal is guided by waveguide 12 into splitter 50 and output from splitter 50 on waveguides 52, 54 and guided thereby into amplifier 30. Each waveguide 70 of amplifier 30 amplifies the optical signal by approximately 3 dB. Both the input facet 32 and output facet 34 of amplifier 30 are anti-reflective to light, and the amplifier may be generally referred to as a transmission mode amplifier. The light signal may be selectively output from the amplifier 30 on either output Y or output Z via waveguide 14 or 16, respectively, as described in more detail below.

Referring next to FIG. 2, an alternative embodiment of an optical switch 10 constructed in accordance with the present invention is there depicted. The switch 10 includes a plurality of passive optical components, designated by reference numerals 50, 150 and 1250. A −3 dB optical power splitter 50 is again optically coupled to the input waveguide 12 for receiving a light signal propagating therethrough. The output waveguides 52, 54 of the splitter 50 provide an optical path between the splitter 50 and two optical isolators 150, 150′ and guide a light signal from the splitter to each isolator 150, 150′. The isolators 150, 150′ each prevent reverse propagation of a light signal, i.e., prevent propagation into the outputs of the splitter 50. Waveguides 52′, 54′ provide an optical path between the optical isolators 150, 150′ and two optical circulators 1250, 1250′. Light passes through the circulators 1250, 1250′ when propagating from left to right (in the drawings) and is guided by waveguides 52″, 54″ into the amplifier 30 through the anti-reflective coating 74 of the input facet 32, is reflected by the high reflectivity coating 72 of the output facet 34 (described in more detail below), exits the amplifier 30 via the input facet 32 and re-enters the circulators 250, 250′ propagating in a direction from right to left (in the drawings). Light does not re-enter waveguide 52′ or 54′. Instead, the circulators 1250, 1250′ redirect the light signal to an output of the switch 10, generally designated by reference letters Y and Z, via a respective output waveguide 14, 16. The amplifier 30 of the embodiment of FIG. 2 is a dual-pass 3 dB (6 dB total) gain amplifier, also referred to herein as a reflection mode amplifier. The light signal input via waveguide 12 may be selectively switched between either of output Y or Z through the two optical amplifiers 70.

The waveguides provided as part of an optical switch 10 constructed in accordance with the present invention may comprise photonic-wire or photonic-well waveguides, and may be polarization insensitive. Exemplary waveguides are disclosed in U.S. Pat. Nos. 5,790,583 and 5,878,070, the entire contents of which are hereby incorporated in their respective entireties.

The low gain optical amplifier 30 of the present invention may be constructed in various configurations according to the various embodiments of the present invention. Those various embodiments will now be discussed in detail. However, it will be recognized by persons skilled in the art and from the disclosure provided herein that the following embodiments of the optical amplifier are illustrative, non-limiting examples, and that other configurations are also contemplated by the present invention.

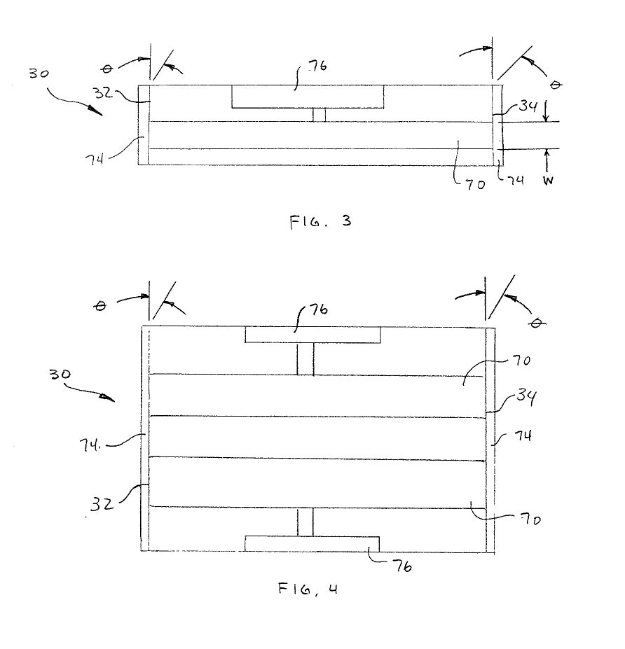

Referring next to FIGS. 3 and 4, two embodiments of a longitudinal low gain optical amplifier 30 are there depicted. The following discussion will be directed generally at the embodiment of FIG. 3, in which a single waveguide 70 is provided in the amplifier 30, it being understood that such discussion applies equally to the embodiment of FIG. 4, in which two generally parallel waveguides 70 are provided. The amplifier 70 includes input and output facets 32, 34 that are preferably angled to provide a facet tilt angle θ ranging from approximately 7 to 8 degrees. The facets 32, 34 are coated with a generally anti-reflective coating 74 that provides a facet power reflectivity of less approximately 0.001. A light signal enters the amplifier 30 through the input facet 32 and exits via the output facet 34.

The waveguide 70 may be a ridge waveguide with a bulk active region, a multiple quantum well active region, or it may be a buried heterojunction waveguide having either a bulk or multiple quantum well active region, as a routine matter of design choice.

A metal or metallic electrode 76 contacts the waveguide 70 and provides a path through which an electric field or signal may be introduced into the active region 80 (discussed in more detail below) of the waveguide 70. The effective refractive index of the waveguide 70 may be changed in the presence of the electrical signal or field (due to the electro-optic effect). A change in the waveguide 70 refractive index will cause a change in the optical characteristics of the waveguide 70, including the wavelength that will be guided/amplified by the waveguide 70 and active region 80. Thus, the wavelength selectively of the waveguide 70 may be changed by introduction of an electrical signal or field, thus enabling selective transmission or switching of desired wavelengths.

The waveguide 70 may range from approximately 100 to 300 μm in length (i.e., from the input facet 32 to the output facet 34), and may have a width w ranging from approximately 65 to 75 μm. For the embodiment of FIG. 4, the waveguides 70 are preferably separated from each other by a distance sufficient to prevent unwanted light leakage or coupling between the waveguides 70 and to permit connection (i.e., pig-tailing) of two (or more) fiber-optic cables (not shown) at the outputs of Y, Z (see, e.g., FIG. 1).

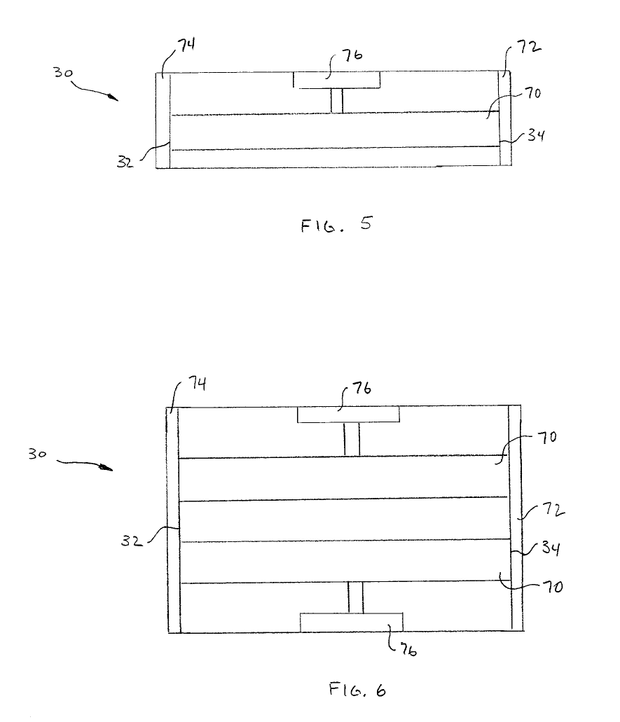

Referring next to FIGS. 5 and 6, an alternative embodiment of a low gain optical amplifier 30 in accordance with the present invention is there depicted. The amplifier 30 depicted in FIGS. 5 and 6 is substantially the same as that depicted in FIGS. 3 and 4, as described above, except that a generally high reflective coating 72 is provided on the output facet 34. Thus, a light signal propagating through the amplifier 30 (i.e., through the waveguide 70) from left to right (in the drawings) is reflected by the high reflective coating 72 so as to propagate from right to left and exit the amplifier 30 via the input facet 32. The amplifier 30 of FIGS. 5 and 6 is thus a dual-pass, 6 dB (3 dB for each pass) gain amplifier.

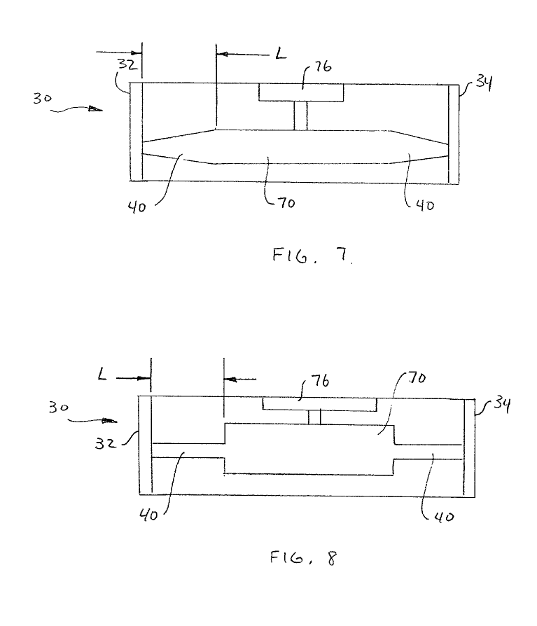

The amplifier 30 of the present invention may also include a monolithically integrated mode size converter 40 to improve coupling efficiency between the amplifier 30 and a fiberoptic cable (not shown), for example, or other light emitting or light propagating device that may be coupled to the amplifier 30. A tapered mode size converter 40 based on mode evolution is depicted in FIG. 7 and a non-tapered mode size converter 40 based on mode interference, arising from mode excitation at the junction, is depicted in FIG. 8. The length L of the mode size converter 40 of FIG. 7 preferably ranges from approximately 200 to 300 micrometers, and is preferably less than approximately 100 micrometers for that of FIG. 8.

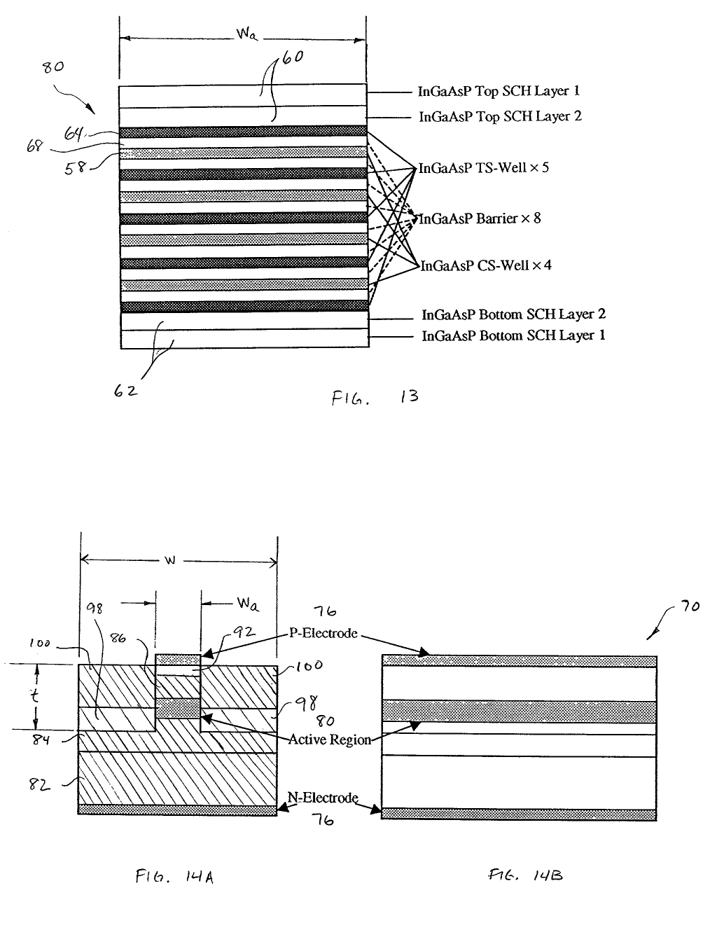

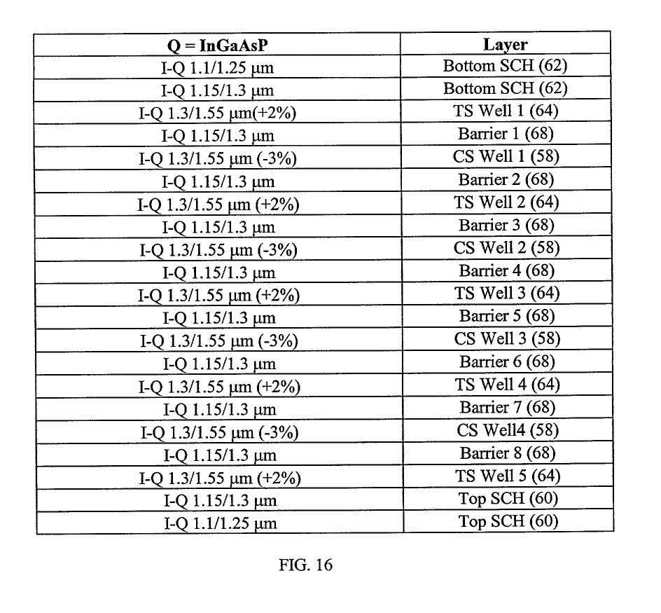

Amplification is provided by an active region 80 defined within the waveguide 70, as depicted in FIGS. 13-15. Referring next to FIG. 13, a multiple quantum well (MQW) active region 80 is there depicted. The active region 80 of the embodiment of FIG. 13 is constructed of alternating compressive strained (CS) quantum well layers 58 and tensile strained (TS) quantum well layers 64 of InGaAsP, for example, or other suitable semiconductor materials. In the embodiment depicted in FIG. 13, 4 compressive strained 58 and 5 tensile strained 64 quantum well layers are provided. A barrier layer 68 of InGaAsP is preferably provided between compressive and tensile strained quantum well layers (providing 8 barrier layers). Top and bottom separate confinement heterostructure (SCH) layers 60, 62 of InGaAsP are provided to complete the active region 80. Each tensile strained 64 and compressive strained layer 58 may range from approximately 3 to 5 nm thick, and each barrier layer 68 may be approximately 10 nm thick. Each top and bottom SCH layer 60, 62 may range from approximately 50 to 100 nm thick. Each layer of the active region 80 may be constructed of a predetermined semiconductor material composition, suitably doped for transmission of a predetermined wavelength (e.g., 1550 nm). The illustrative, non-limiting exemplary material composition and doping concentration for each layer provided in the table of FIG. 16 is suitable for transmission of wavelengths in the 1300 nm band and 1550 nm band, respectively. In FIG. 16, I-Q 1.1/1.25 μm refers to an intrinsic InGaAsP with band-gap transition wavelength at 1.1/1.25 μm, respectively, with lattice matched to the substrate. Also in FIG. 16, I-Q 1.3/1.55 μm (+2%) refers to an intrinsic InGaAsP with band-gap transition wavelength at 1.3/1.55 μm, respectively, with 2% tensile strain relative to the substrate. I-Q 1.3/1.55 μm (−3%) in FIG. 16 refers to an intrinsic InGaAsP with band-gap transition wavelength at 1.3/1.55 μm, respectively, with 3% compressive strain relative to the substrate.

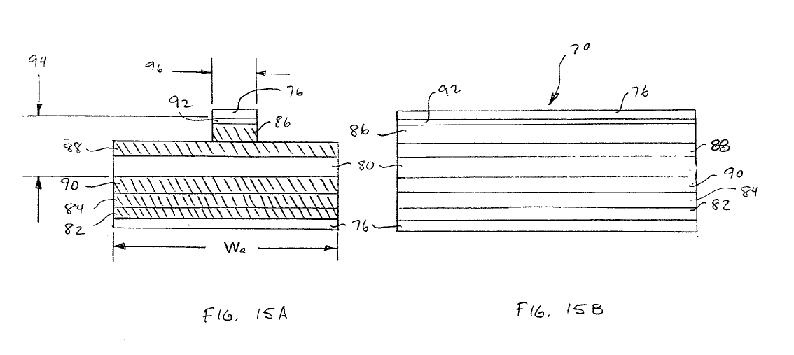

Referring next to FIGS. 14A and 14B, a cross-sectional view and a longitudinal side view of a buried heterojunction waveguide 70 of an optical amplifier 10 constructed in accordance with the present invention is there depicted. The active region 80 may be either a bulk active region or a MQW active region, as a routine matter of design choice. The waveguide 70 is preferably constructed of a substrate 82 of n-doped InP (doping concentration of approximately 3×10¹⁸/cm³) ranging from approximately 100 to 80 μm thick. A bottom cladding layer 84, also preferably of n-doped InP (doping concentration of approximately 5×10¹⁷/cm³) and ranging from approximately 2 to 3 μm thick (in a vertical direction in the drawings) is disposed above the substrate 82. The active region 80, either bulk or MQW, ranges from approximately 0.4 to 0.6 μm (bulk), and from approximately 0.3 to 0.53 μm (MQW) thick, and is disposed within the waveguide 70 and between the bottom cladding layer 84 and top cladding layer 86. The top cladding layer 86 is preferably p-doped InP (doping concentration of approximately 5×10¹⁷/cm³) and ranges from approximately 2.5 to 3 μm thick. A p-doped InGaAs contact cap 92 (doping concentration of approximately 1×10¹⁹/cm³) is disposed above the top cladding layer 86 and preferably ranges from approximately 0.1 to 0.15 μm thick. The electrode 76 comprises both p-type (top electrode) and n-type (bottom electrode) parts. The top p-type electrode is preferably an alloy consisting of Ti, Pt, and Au; while the bottom n-type electrode is preferably an alloy consisting of Au, Ge, and Ni.

Formation of the active region 80 depicted in FIGS. 14A and 14B may be achieved using now known or hereafter developed semiconductor deposition and etching techniques and methods for buried heterojunction devices. For example, the bottom cladding layer 84, active region 80, top cladding layer 86, and contact cap 92 may be initially formed to the width w of the waveguide 70. Formation of the active region 80 to a preferred width wₐ and preferred thickness t may be accomplished using a wet etch process, for example. Thereafter, a p-doped InP layer 98 and a n-doped InP layer 100 (each having a doping concentration of approximately 3×10¹⁷/cm³) may be regrown above the bottom cladding layer 84 and beside the active region 80 to form the buried heterojunction waveguide 70.

Referring next to FIGS. 15A and 15B, a ridge waveguide 70 having a bulk active region 80 constructed in accordance with an embodiment of the present invention is there depicted. A n-doped InP substrate 82 (doping concentration of approximately 3×10¹⁸/cm³) ranging from approximately 100 to 80 μm thick provides a foundation upon which a n-doped InP bottom cladding 84 (doping concentration of approximately 5×10¹⁷/cm³) is disposed. The bottom cladding layer 84 ranges from approximately 2 to 3 μm thick. A bottom guide layer 90, preferably n-doped InGaAsP (doping concentration of approximately 3×10¹⁷/cm³) and ranging from approximately 0.1 to 0.15 μm thick, is disposed on top of the bottom cladding 84. A p-doped bulk active region 80 of InGaAsP (doping concentration of approximately 1×10¹⁷/cm³) and ranging from approximately 0.2 to 0.3 μm thick is provided on top of the bottom waveguide 90. A top guide layer 88 of p-doped InGaAsP (doping concentration of approximately 3×10¹⁷/cm³) and ranging from approximately 0.1 to 0.15 μm thick, a p-doped InP top cladding 86 (doping concentration of approximately 5×10¹⁷/cm³) ranging from approximately 2.5 to 3 μm thick, and a p-doped InGaAs contact cap 92 (doping concentration of approximately 1×10¹⁹/cm³), are disposed in generally stacked relation to provide the waveguide 70 of FIGS. 15A and 15B.

The present invention uses a modified conventional SOA structure in which the size of the active region and the cladding layer are modified to reduce the polarization sensitivity and the gain recovery time by sacrificing the optical gain. Specifically, for an amplifier (i.e., SOA) with a bulk active region, the width, wₐ, of the active region 80 (also referred to herein as the core) ranges from approximately 0.4 to 0.6 μm, while that of a conventional SOA typically ranges from 0.2 to 0.4 μm. For a buried heterojunction structure, the core of the present invention is narrowed to approximately 0.7 μm. This provides a core having a quasi-square shape (i.e., generally symmetrical) which tends to reduce polarization sensitivity. For a SOA having a multiple quantum well (MQW) active region, mixed compressive and tensile strained quantum wells are used together with a TE/TM mode confinement configuration to balance TE and TM modal gains.

In the above-described embodiments of the active region 80 and waveguide 70, any now known or hereafter developed semiconductor etching and formation techniques and methods may be used to selectively deposit, dope, etch, re-grow, etc., the various layers that comprise the waveguide 70 and active region 80.

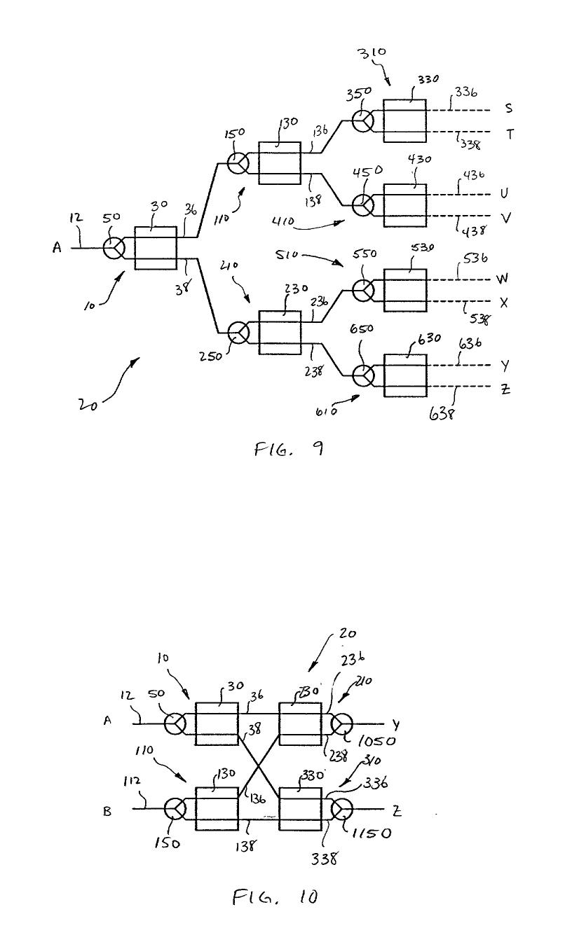

A variety of optical switches and switch matrices (also referred to herein as switch fabric) may be constructed in accordance with the present invention. For example, FIGS. 9-12 depict illustrative, non-limiting embodiments of such switches and switch matrices. Referring first to FIG. 9, a 1×N optical switch 20 comprises a plurality of monolithically formed and optically connected optical switches 10, 110, 210, 310, 410, 510, 610, each constructed in accordance with the present invention and each comprising a −3 dB passive optical splitter 50, 150, 250, 350, 450, 550, 650, and a two channel, single-pass 3 dB gain optical amplifier 30, 130, 230, 330, 430, 530, 630. An optical signal provided at the input A propagates through the optical switch 20 without being amplified due to the offsetting −3 dB loss introduced by the splitter 50 and 3 dB gain provided by the amplifier 50. A single input A may be selectively switched between any of a plurality of outputs S-Z and output from the switch 20 via respective output waveguide 336, 338, 436, 438, 536, 538, 636, 638. By applying an electrical signal or electrical field to the electrode 76 (see e.g., FIGS. 3-8), the wavelength selectively of each amplifier 30 may be controlled. Thus, each amplifier 30 of the switch 20 may be tuned so that a desired wavelength is output from a selective output and thus propagates through the switch 20 over a predetermined path and is output from the switch 20 via a selected one of the N outputs. For example, by selectively tuning amplifiers 30, 130 and 330, an optical signal input at A may be output from the switch 20 at output T.

Referring next to FIG. 10, a 2×2 optical switch 20 comprises four monolithically formed optical switches 10, 110, 210, 310. Switches 10 and 110 each include a −3 dB passive optical splitter 50, 150 optically coupled to a two channel, single-pass 3 dB gain optical amplifier 30, 130. Switches 210 and 310 each include a −3 dB passive combiner 1050, 1150 optically coupled to a two channel, single-pass 3 dB gain optical amplifier 230, 330. A first optical switch 10 may receive an optical signal on input A, which is attenuated by a first passive splitter 50 and amplified by a first single-pass 3 dB amplifier 30. The output of the first amplifier 30 is optically connected via waveguide 36 to the input of a second single-pass 3 dB amplifier 230, which amplifies the optical signal. The output of the second amplifier 230 is attenuated (approximately back to the power level of the optical signal input at input A) by a second −3 dB passive combiner 1050 and output from the switch 20 on output Y. That same optical signal present on input A may alternatively be output from the switch 20 on output Z by being output from amplifier 30 via waveguide 38 and input to amplifier 330.

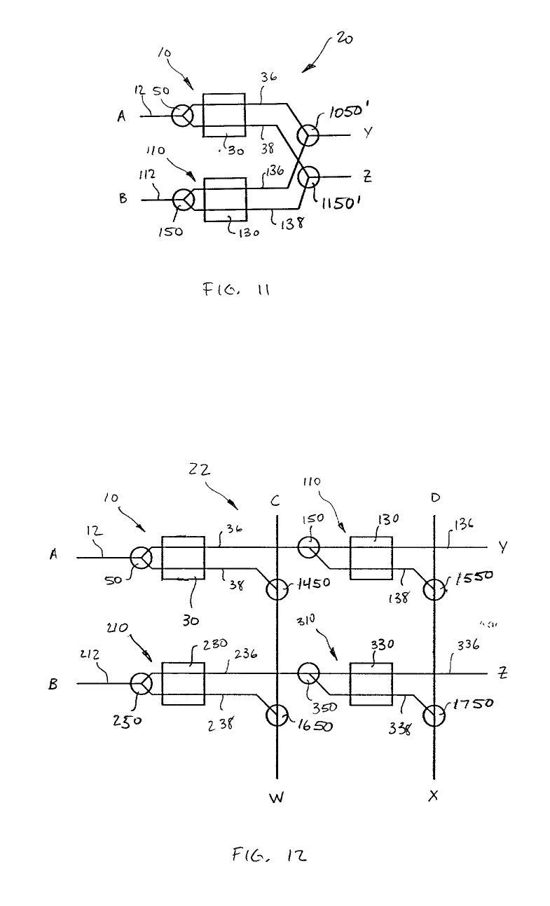

An alternative embodiment of a 2×2 switch 20 in accordance with the present invention is depicted in FIG. 11. Each optical amplifier 30, 130 of that embodiment is preferably a two channel, single-pass 6 dB amplifier optically coupled to two passive combiners 1050′, 1150′. The configuration of FIG. 11 (and also that of FIG. 10) are scaleable to provide a N×N switch 20.

Referring next to FIG. 12, the optical switch 10 of the present invention may be used to construct a 2×2 switch matrix 22 having four inputs A-D and four outputs W-Z. In that embodiment, a plurality of switches 10, 110, 210, 310 each include a 3 dB splitter 50, 150, 250, 350 and an optical amplifier 30, 130, 230, 330. A waveguide 38, 138, 238, 338 at an output of each amplifier 30, 130, 230, 330 each connect to an optical combiner 1450, 1550, 1650, 1750 and from there to an output W or X. Any of the switches 10, 110, 210, 310 may be selectively tuned to redirect an optical signal having a predetermined wavelength present at either input A or input B to any of the four outputs W-Z. For example, when a light signal is present at input A, switch 10 may be tuned so that that light signal is output from output W. The light signal propagates along waveguide 12 into splitter 50 and from there, into amplifier 30. The light signal is output from amplifier 30 via waveguide 38 and into combiner 1450. If a light signal is also present at input C, that signal combines with the signal from input A, and may also combine with a signal from input B in combiner 1650. Output from the switch matrix 22 in this example is via output W.

It will be obvious to persons skilled in the art and from the disclosure provided herein that any of the amplifier 30 embodiments disclosed herein may be used to construct the switches and switch fabrics depicted n FIGS. 9-12.

In addition to lower cost and higher yield, the present invention is operable at higher switching speeds, exhibits zero insertion loss or even gain, and has a large extinction ratio (the ratio of the power of a plane-polarized beam that is transmitted through a polarizer placed in its path with its polarizing axis parallel to the beam's plane, as compared with the transmitted power when the polarizer's axis is perpendicular to the beam's plane).

The present invention also utilizes the low gain region of an optical amplifier. In the present invention, a fiber-to-fiber gain of approximately 3 dB is sufficient for 1×N and N×N non-matrix switches, and a maximum gain of approximately 6 dB is sufficient for N×N matrix switches. The present invention also provides a scaleable matrix switch, even after packaging.

Thus, the present invention utilizes many of low gain (i.e., 3 dB) SOA devices instead of using fewer high gain (i.e., >6 dB) SOA devices. The low gain SOAs of the present invention are also combined with fiber components (e.g., FOCs), instead of being coupled with other types of waveguides. That construction and configuration produces various switch architectures (e.g., matrix and non-matrix) that have heretofore not been known.

Thus, while there have been shown and described and pointed out novel features of the present invention as applied to preferred embodiments thereof, it will be understood that various omissions and substitutions and changes in the form and details of the disclosed invention may be made by those skilled in the art without departing from the spirit of the invention. It is the intention, therefore, to be limited only as indicated by the scope of the claims appended hereto.

It is also to be understood that the following claims are intended to cover all of the generic and specific features of the invention herein described and all statements of the scope of the invention which, as a matter of language, might be said to fall therebetween.

What is claimed is:

1. A guided wave optical switch comprising:
a low gain optical amplifier having input and an output facets, at least one of which is anti-reflective to light, said amplifier having two waveguides each including an active region having a generally symmetrical cross-sectional shape to reduce polarization sensitivity of said waveguides; and
a passive optical component optically coupled to said optical amplifier and for receiving a light signal from an optical source and directing the light signal to said optical amplifier for amplification thereby and for output therefrom, said optical amplifier and said passive optical component being monolithically formed on a semiconductor substrate.

2. A guided wave optical switch as recited in claim 1, wherein each said waveguide of said optical amplifier is a ridge waveguide.

3. A guided wave optical switch as recited in claim 2, wherein each said active region comprises a bulk active region.

4. A guided wave optical switch as recited in claim 2, wherein each said active region comprises a multiple quantum well active region having alternate compressive and tensile strained quantum wells and separate confinement layers, said active region also having substantially balanced transverse electric and transverse magnetic modal gains.

5. A guided wave optical switch as recited in claim 1, wherein each said waveguide of said optical amplifier is a buried heterojunction waveguide having a core with a width of approximately 0.7 μm.

6. A guided wave optical switch as recited in claim 5, wherein each said active region comprises a bulk active region.

7. A guided wave optical switch as recited in claim 5, wherein each said active region comprises a multiple quantum well active region having alternate compressive and tensile strained quantum wells and separate confinement layers, said active region also having substantially balanced transverse electric and transverse magnetic modal gains.

8. A guided wave optical switch as recited in claim 1, wherein said passive optical component comprises a single-mode −3 dB optical power splitter having an input and two outputs and that splits a light signal received at said input equally between said two outputs, each one of said two outputs being optically coupled to one of said waveguides of said low gain optical amplifier.

9. A guided wave optical switch as recited in claim 1, wherein said low gain optical amplifier has a single-pass gain of approximately 3 dB.

10. A guided wave optical switch as recited in claim 1, wherein each said waveguide of said optical switch includes a mode size converter.

11. A guided wave optical switch as recited in claim 10, wherein said mode size converter is a mode evolution converter.

12. A guided wave optical switch as recited in claim 10, wherein said mode size converter is a mode interference converter.

13. A guided wave optical switch as recited in claim 1, wherein said input and an output facets are both anti-reflective to light and each have a facet tilt angle of between approximately 7° and 80°.

14. A guided wave optical switch as recited in claim 1, wherein said input facet is anti-reflective to light and said output facet is highly reflective to light, and wherein said passive optical component comprises:
a single-mode optical power splitter having an input and two outputs and that splits a light signal received at said input approximately equally between said two outputs;
an optical isolator optically connected at each of said two outputs of said optical power splitter for preventing propagation of a light signal into each of said two outputs of said power splitter; and
an optical circulator optically connected to each optical isolator for permitting a light signal to pass through said optical circulator from an input to a first output when the light signal is propagating through said optical circulator in a first direction, and for permitting a light signal to pass through said optical circulator from said first output to a second output when a light signal is propagating through said optical circulator in a second direction.

15. A guided wave optical switch as recited in claim 1, further comprising an electrode coupled to each said active region and through which an electrical signal may be directed into said active region to generate optical gain within each said waveguide.

16. A guided wave optical switch as recited in claim 1, wherein said optical amplifier, said passive optical component, and the substrate are constructed from group III-V semiconductors.

17. A guided wave optical switch as recited in claim 16, wherein said optical amplifier, said passive optical component, and the substrate are constructed from Indium Phosphide.

18. A M×N optical switch comprising:
a plurality of optically connected guided wave optical switches, each said switch comprising:
a low gain optical amplifier having input and an output facets, at least one of which is anti-reflective to light, said amplifier having two generally parallel waveguides each including an active region having a generally symmetrical cross-sectional shape to reduce polarization sensitivity of said waveguides; and
a passive optical component optically coupled to said optical amplifier and for receiving at an input a light signal from an optical source and splitting the light signal equally between two outputs, each of said two outputs being optically connected to one of said waveguides of said optical amplifier to provide light signal input thereto, said optical amplifier and said passive optical component being monolithically formed on a semiconductor substrate.

19. A M×N optical switch as recited by claim 18, wherein M equals 1.

20. A M×N optical switch as recited by claim 18, wherein M is equal to N.

21. A M×N optical switch as recited by claim 18, wherein each said waveguide of each said optical amplifier is a ridge waveguide.

22. A M×N optical switch as recited by claim 21, wherein each said active region comprises a bulk active region.

23. A M×N optical switch as recited in claim 21, wherein each said active region comprises a multiple quantum well active region having alternate compressive and tensile strained quantum wells and separate confinement layers, said active region also having substantially balanced transverse electric and transverse magnetic modal gains.

24. A M×N optical switch as recited in claim 18, wherein each said waveguide of each said optical amplifier is a buried heterojunction waveguide having a core with a width of approximately 0.7 μm.

25. A M×N optical switch as recited in claim 24, wherein each said active region comprises a bulk active region.

26. A M×N optical switch as recited in claim 24, wherein each said active region comprises a multiple quantum well active region having alternate compressive and tensile strained quantum wells and separate confinement layers, said active region also having substantially balanced transverse electric and transverse magnetic modal gains.

27. A M×N optical switch as recited in claim 18, wherein said optical amplifier, said passive optical component, and the substrate are constructed from group III-V semiconductors.

28. An optical switch matrix having M inputs and N outputs, said switch matrix comprising:
a plurality of optically connected guided wave optical switches, each said switch comprising:
a low gain optical amplifier having input and an output facets, at least one of which is anti-reflective to light, said amplifier having two generally parallel waveguides each including an active region having a generally symmetrical cross-sectional shape to reduce polarization sensitivity of said waveguides; and
an optical splitter optically coupled to said optical amplifier and for receiving at an input a light signal from an optical source and splitting the light signal equally between two outputs, each of said two outputs being optically connected to one of said two waveguides of said optical amplifier to provide light signal input thereto, said optical amplifier and said passive optical component being monolithically formed on a semiconductor substrate; and
a plurality of optical combiners, a first group of said plurality of optical combiners having a first input optically connected to one of the M inputs and a second input optically connected to receive an optical signal from one of said optical amplifiers, and a second group of said plurality of optical combiners having a first input optically connected to receive an optical signal from an output of one of said first group of optical combiners, and a second input optically connected to receive an optical signal from one of said optical amplifiers, said second group of optical combiners each having an output comprising one of the N outputs;
said plurality of optical switches and said plurality of optical combiners being monolithically formed on a semiconductor substrate.

29. An optical switch matrix as recited in claim 28, wherein each said waveguide of each said optical amplifier is a ridge waveguide.

30. An optical switch matrix as recited by claim 29, wherein each said active region comprises a bulk active region.

31. An optical switch matrix as recited in claim 29, wherein each said active region comprises a multiple quantum well active region having alternate compressive and tensile strained quantum wells and separate confinement layers, said active region also having substantially balanced transverse electric and transverse magnetic modal gains.

32. An optical switch matrix as recited in claim 28, wherein each said waveguide is a buried heterojunction waveguide having a core with a width of approximately 0.7 μm.

33. An optical switch matrix as recited in claim 32, wherein each said active region comprises a bulk active region.

34. An optical switch matrix as recited in claim 32, wherein each said active region comprises a multiple quantum well active region having alternate compressive and tensile strained quantum wells and separate confinement layers, said active region also having substantially balanced transverse electric and transverse magnetic modal gains.

35. An optical switch matrix as recited in claim 28, wherein said optical amplifier, said optical splitters, said optical combiners, and the substrate are constructed from group III-V semiconductors.
